(19) United States
(12) Patent Application Publication
(10) Pub. No.: US 2018/0272960 A1
(43) Pub. Date: Sep. 27, 2018

(54) VEHICLE HEAD LINING AND TOUCH CONTROL SYSTEM INCLUDING THE SAME

(71) Applicants: Hyundai Motor Company, Seoul (KR); Kia Motors Corporation, Seoul (KR); Foundation of Soongsil University-Industry Cooperation, Seoul (KR)

(72) Inventors: Jin-Ho HWANG, Seoul (KR); Min-Ki Choi, lncheon (KR); Joo-Yong Kim, Seoul (KR)

(73) Assignees: Hyundai Motor Company, Seoul (KR); Kia Motors Corporation, Seoul (KR); Foundation of Soongsil University-Industry Cooperation, Seoul (KR)

(21) Appl. No.: 15/855,917

(22) Filed: Dec. 27, 2017

(30) Foreign Application Priority Data
Mar. 22, 2017 (KR) 10-2017 -0035966

(51) Int. Cl. B60R 13/02; B60R 16/023; G06F 3/044; G06F 3/041

(52) U.S. Cl. CPC B60R 13/0212; B60R 16/023; B60R 2013/0287; G06F 3/0416; G06F 3/044

(57) ABSTRACT

A touch control system for a vehicle may include a detector portion disposed on a head lining of a vehicle, and a communication module configured to receive a signal from the detector portion and transmit the signal to a device to be controlled by the signal.

### CROSS-REFERENCE(S) TO RELATED APPLICATIONS

The present application claims priority to Korean Patent Application No. 10-2017-0035966, filed on Mar. 22, 2017, the entire contents of which is incorporated herein for all purposes by this.

### BACKGROUND OF THE INVENTION

### Field of the Invention

The present invention relates to a head lining within a vehicle ceiling, and a touch control system including the same.

### Description of Related Art

In recent years, user-centered designs based on Information Technology (IT) have been in the spotlight to express their individuality. An internal space of a vehicle is a space in which a driver and occupants move and inhabit while sensitizing information, including sight, touch, and depth perception, by humans is generated in view of inhabitable volume. Therefore, it is important to develop products considering uniqueness, aesthetics, and ease of use of various members including seats, dashboards, door trims, and controllers forming an internal design.

To cope with such a tendency recently, vehicle manufacturers upgrade existing simple controllers including short-circuit/open buttons and solenoid jogs and apply new techniques including capacitive or optical type touch buttons in succession. Furthermore, each of the manufacturers increases convenience of use of Information and Communication Technology (ITC) members, draws harmony with other components, and expresses distinctive and refined design of internal members (center fascia, overhead console, dashboard, door trim, etc.).

Especially, advanced manufacturers lead in the industry by developing new concept internal controllers, systems, and materials, and thus solidify their premium brand images and identities as well as contributing to an improvement in national brand image.

Accordingly, it is necessary to develop and apply new concept emotional controllers for vehicles in a limited region, in which a relatively small number of controllers are disposed due to material and other technical problems, to differentiate ones technologies from competitors and boost one's brand image.

Meanwhile, more than approximately 60 to 80% of vehicle internal controllers are concentrated in the center fascia, and the controllers encounter spatial limitations due to dispositions of more IT-based devices in recent years.

For the above reason, a method of moving buttons to a door trim or a center console or providing the buttons in display functions is attempted to resolve these problems. However, the given solution is not an ultimate alternative because there is a high risk of decreasing the intuition of an overall system.

The internal member which represents the most remarkable change in recent years is a controller. The reason is because there is a demand for a large number of controllers that can operate a variety of functions, including safety and convenience functions by electronic communication devices and various detectors and infotainment functions, in addition to intrinsic control functions including movement and stop of vehicles, since these functions have been provided in the vehicles in recent years.

Furthermore, most touch controllers applied to a vehicle internal including a center fascia or a door trim have a disadvantage for visibility, safety, and convenience, compared to non-touch controllers.

The information disclosed in this Background of the Invention section is only for enhancement of understanding of the general background of the invention and should not be taken as an acknowledgment or any form of suggestion that this information forms the prior art already known to a person skilled in the art.

### BRIEF SUMMARY

Various aspects of the present invention are directed to providing a vehicle head lining that enables vehicle is configured to be controlled by touch input and enables a conventional spatial limitation for control panels to be overcome, and a touch control system including the same.

Other various aspects of the present invention can be understood by the following description, and become apparent with reference to the exemplary embodiments of the present invention. Also, it is obvious to those skilled in the art to which the present invention pertains that the objects and advantages of the present invention can be realized by the means as claimed and combinations thereof.

In accordance with various exemplary embodiments of the present invention, a touch control system for a vehicle may include a detector disposed on a head lining of a vehicle, and a communication module configured to receive a signal from the detector portion and transmit the signal to a device to be controlled by the signal.

The detector portion may be formed of a conductive yarn in a knitting form, and formed on a portion of a skin portion of the head lining.

The skin portion of the head lining may be formed of the conductive yarn and an insulating yarn, and manufactured by a circular knitting method.

The conductive yarn and the insulating yarn may include a same pattern.

The conductive yarn may use a 60 to 140 denier twisted yarn formed by twisting two single yarns having a denier of 30 to 70.

The touch control system may further include a circuit portion including a signal transmission yarn configured to transmit a signal input from the conductive yarn to the communication module.

The circuit portion may include a Main Control Unit (MCU) and a reference resistor for detector implementation according to a capacitive principle.

The signal transmission yarn may be connected to a rear surface of the skin portion through a connector formed on one side of the skin portion.

The connector may be coated with conductive ink and mounted on the skin portion.

The connector may have a snap button shape.

The communication module may transmit a control signal to the device to be controlled in a Bluetooth manner.

In accordance with various exemplary embodiments of the present invention, a vehicle head lining may include a skin portion, a portion of which is formed with a conductive yarn in a knitting form, wherein a signal for controlling a device to be controlled is input in a touch manner by the conductive yarn.

The skin portion may be formed of the conductive yarn and an insulating yarn, and be manufactured by a circular knitting method.

The conductive yarn and the insulating yarn may include the same pattern.

The conductive yarn may use a 60 to 140 denier twisted yarn formed by twisting two single yarns having a denier of 30 to 70.

The signal input from the conductive yarn may be transmitted through a signal transmission yarn which is disposed on the skin portion and is connected to the conductive yarn.

The methods and apparatuses of the present invention and apparatuses of the present invention have other features and advantages which will be apparent from or are set forth in more detail in the accompanying drawings, which are incorporated herein, and the following Detailed Description, which together serve to explain certain principles of the present invention

### BRIEF DESCRIPTION OF THE DRAWINGS

FIG. 1 is a view schematically illustrating a touch control system according to an exemplary embodiment of the present invention;

FIG. 2 is an enlarged view of portion “A” in FIG. 1;

FIG. 3 is a view illustrating a portion of one component of the touch control system according to an exemplary embodiment of the present invention;

FIG. 4 is a circuit diagram illustrating one component of the touch control system according to an exemplary embodiment of the present invention; and

FIG. 5 is a view illustrating a configuration of a head lining according to another exemplary embodiment of the present invention.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In various exemplary embodiments, known technologies or detailed descriptions may be reduced or omitted to avoid obscuring appreciation of the present invention by a person of ordinary skill in the art.

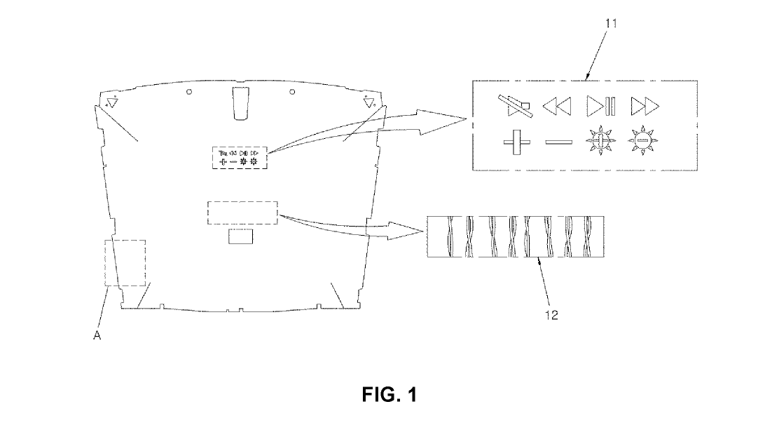

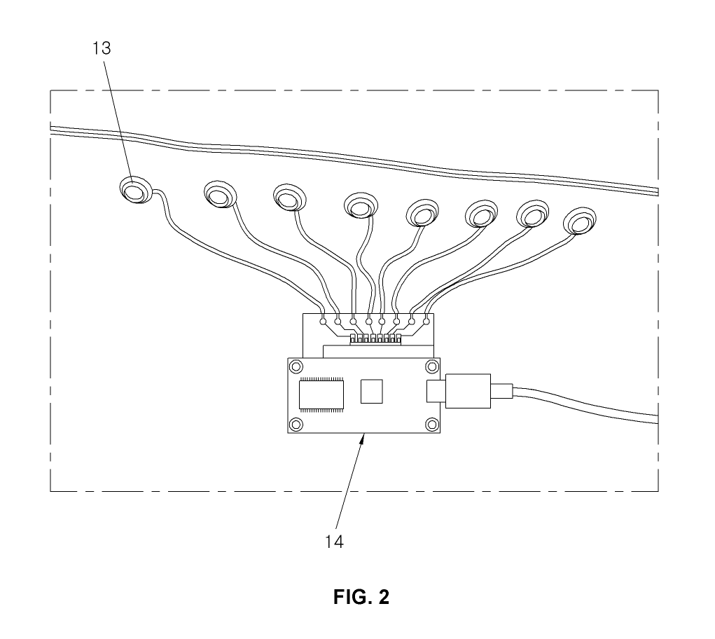

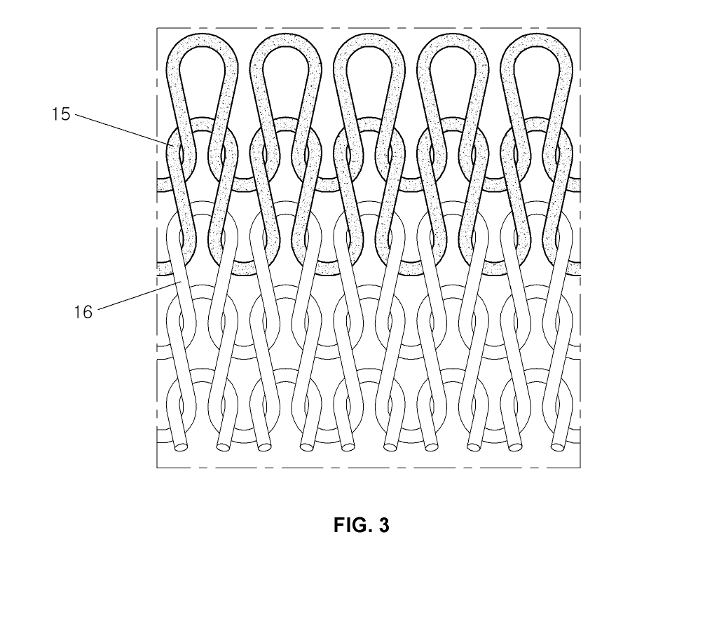

FIG. 1 is a view schematically illustrating a touch control system according to an exemplary embodiment of the present invention. FIG. 2 is an enlarged view of portion “A” in FIG. 1. FIG. 3 is a view illustrating a portion of one component of the touch control system according to the exemplary embodiment of the present invention.

Hereinafter, a vehicle head lining and a touch control system including the same according to exemplary embodiments of the present invention will be described with reference to FIG. 1, FIG. 2, and FIG. 3.

The touch control system according to an exemplary embodiment of the present invention is applied to a vehicle and controls main functions of the vehicle. The touch control system is an intuitive and convenient control system that enables is configured to be input in a new region and not an existing region, and adopts an input mode different from existing methods.

To this end, the touch control system provides an input portion for controlling input to the head lining within the ceiling of the vehicle.

FIG. 1 schematically illustrates the head lining and the touch control system including the same. Referring to FIG. 1 and FIG. 2, the touch control system includes a detector portion 11 on the head lining, a circuit portion for electric connection, a plurality of connectors 13, and a communication module 14.

The head lining is a member that occupies the largest portion inclusive of a textile material, except for components including lighting and handles, in a ceiling. The head lining includes polyurethane foam having shock absorption and insulation properties for a comfortable internal of the vehicle and safety protection of occupants therein, while the skin portion thereof includes a textile material including non-woven fabric, knit, leather, or suede.

The touch control system according to the exemplary embodiment of the present invention includes the detector portion 11 provided on the head lining, and in the skin portion of the head lining including textile material, a portion thereof includes a conductive textile material. Thus, the detector portion 11 is used as a detector that may detect a touch of an occupant's finger, and multimedia devices, convenient devices, and the like of the vehicle may be operated by determination of whether or not the detector detects the touch.

The detector portion 11 includes a conductive textile in a knitting form, and a non-detector portion includes an insulating textile. Thus, a conductive yarn 15 and an insulating yarn 16 are properly mixed and configured with each other when the textile is manufactured, as illustrated in FIG. 3.

That is, the detector portion 11 includes only a textile (100% textile) and formed of a knit-textile integrated conductive layer.

The detector portion 11 is a textile-made element that enables multi-touch detection, and the touch control system may also include two or more detector portions that are not shorted to each other.

Warp knitting and circular knitting are representative methods of manufacturing knitting. The warp knitting method is very vulnerable to detecting since it must use a complex yarn formed by twisting a metal thread and an insulating yarn, instead of a plated yarn, as frictional force of the yarn is required in a feeding process.

Accordingly, the present invention manufactures the textile using the plated yarn by the circular knitting method.

The circular knitting method is a method of feeding a yarn in a lateral (transverse) direction to form a textile. To form two or more detector portions that enable multi-touch detection, they are manufactured by intersecting and feeing a conductive plated yarn and an insulating PET yarn with the circular knitting method, in which case the conductive yarn and the insulating yarn are woven in a same pattern.

Here, a number of feeders is 70 to 130 and a speed of the feeders is 5 to 15 RPM.

A 60 to 140 denier twisted yarn formed by twisting two single yarns having a denier of 30 to 70 is used as the plated yarn for optimum conditions, and the PET yarn is manufactured by twisting two single yarns having a denier of 50 to 80 or by twisting a 50 to 80 denier polyethylene terephthalate (PET) single yarn and a 20 to 50 denier polyurethane (PU) single yarn.

Next, the circuit portion is not formed of a wire or a film, but instead formed by inserting signal transmission yarns 12 into the textile and connecting the detector portion 11 to the communication module 14.

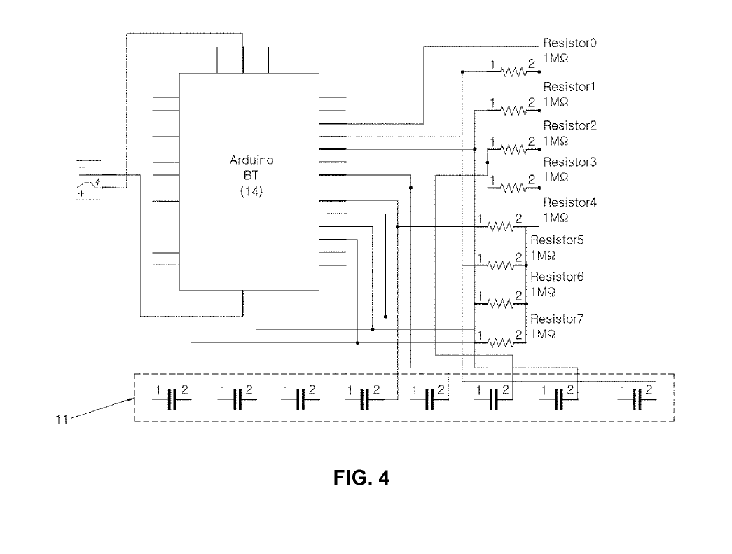

That is, the circuit portion is configured to connect the detector portion 11 to the communication module 14 with the signal transmission yarns 12, and includes a Main Control Unit (MCU) and reference resistors (1 MΩ) for detector implementation according to a capacitive principle, as illustrated in FIG. 4.

FIG. 4 illustrates Arduino having the MCU therein.

By way of example, eight signals are input to the detector portion 11 in the exemplary embodiment of the present invention. Therefore, eight detecting digital pins are applied thereto, reference resistors are connected to respective detecting pins, and a source pin shares ends passing through the resistors and is connected thereto.

The signal transmission yarns 12 are connected to the communication module 14, in which case the detector portion 11 and the signal transmission yarns 12 are provided on the skin portion of the head lining, and the communication module 14 is disposed on an opposite surface of the head lining to prevent being exposed in appearance. Therefore, the connectors 13 having a snap button shape are formed at one side of the head lining, and the signal transmission yarns 12 are connected to the communication module 14 through the connectors 13, as illustrated in FIG. 2.

Here, each of the connectors 13 is mounted after the contact surface between an electrode portion on the textile, and the snap button shaped connector is coated with conductive ink to minimize a contact resistance therebetween.

The communication module 14 converts the signals detected by the detector portion 11 and transmits the converted signals to multimedia devices or other convenient devices within the vehicle through wired and wireless communication.

Although the communication module 14 may transmit information to various devices by wired communication, a low-power Bluetooth (BLE)-based communication module can be utilized due to characteristics of the vehicle, and the BLE shares and utilizes two power supply pin and digital pin of the circuit portion.

As described above, the touch control system according to the exemplary embodiment of the present invention utilizes the conductive yarn, the detector portion is formed on the skin portion of the head lining, and the circuit portion is formed by the signal transmission yarns. Therefore, it is possible to improve vehicle internal design and functionally enable more consumer-friendly control.

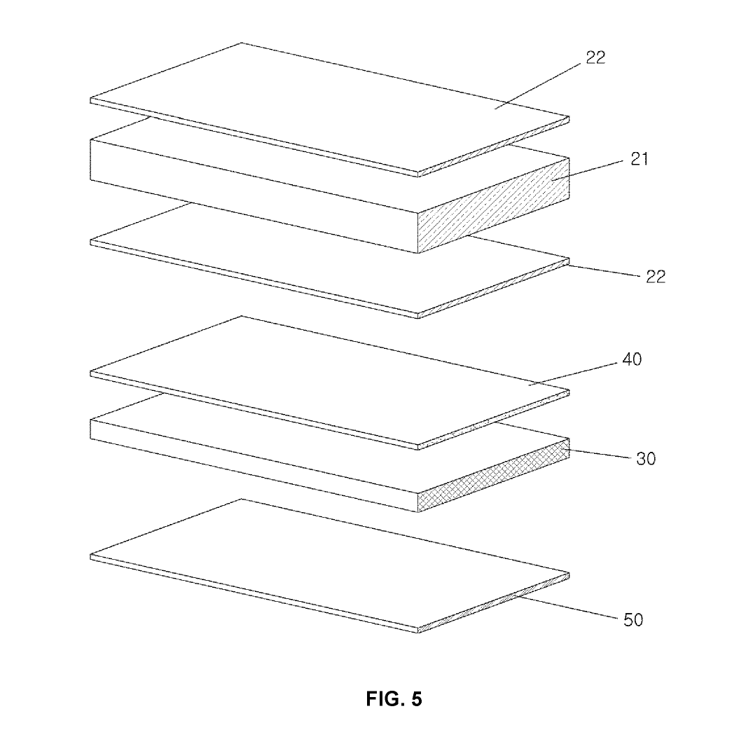

FIG. 5 illustrates a configuration of the head lining including the skin portion provided with the touch control system.

The head lining includes an upper portion and a lower portion, and both portions are adhered by an adhesive film 40 therebetween.

The upper portion includes a polyurethane foam 21 located between upper and lower glass fiber non-woven fabrics 22, and the lower portion include a polyurethane sponge 30.

The skin portion 50, on which the detector portion is mounted, is the lowest layer of the head lining to be exposed to the internal of the vehicle.

The head lining is entirely produced in a form suitable for the vehicle while undergoing a thermal compression process of performing coating and preheating and a pressure process.

In accordance with a vehicle head lining and a touch control system including the same according to exemplary embodiments of the present invention, since control functions are input through the head lining, it is possible to resolve a conventional spatial limitation for control input device in a vehicle and to maintain the intuition of the overall system.

Furthermore, since the functions are controlled by touch input, it is possible to enhance visibility, safety, and convenience.

Thus, it is possible to contribute to enhance a product image through implementation of an independent identity.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments, as well as various alternatives and modifications thereof. It is intended that the scope of the invention be defined by the Claims appended hereto and their equivalents.

What is claimed is:

1. A touch control system for a vehicle, comprising:
a detector portion disposed on a head lining of the vehicle; and
a communication module configured to receive a signal from the detector portion and transmit the signal to a device to be controlled by the signal.

2. The touch control system of claim 1, wherein the detector portion is formed of a conductive yarn in a knitting form, and is formed on a portion of a skin portion of the head lining.

3. The touch control system of claim 2, wherein the skin portion of the head lining is formed of the conductive yarn and an insulating yarn, and is manufactured by a circular knitting method.

4. The touch control system of claim 3, wherein the conductive yarn and the insulating yarn include a same pattern.

5. The touch control system of claim 3, wherein the conductive yarn utilizes a 60 to 140 denier twisted yarn formed by twisting two single yarns having a denier of 30 to 70.

6. The touch control system of claim 2, further including a circuit portion having a signal transmission yarn configured to transmit a signal input from the conductive yarn to the communication module.

7. The touch control system of claim 6, wherein the circuit portion includes a Main Control Unit (MCU) and a reference resistor for detector implementation according to a capacitive principle.

8. The touch control system of claim 6, wherein the signal transmission yarn is connected to a rear surface of the skin portion through a connector formed on a side of the skin portion.

9. The touch control system of claim 8, wherein the connector is coated with conductive ink and is mounted on the skin portion.

10. The touch control system of claim 9, wherein the connector has a snap button shape.

11. The touch control system of claim 6, wherein the communication module transmits a control signal to the device to be controlled in a Bluetooth manner.

12. A vehicle head lining comprising:
a skin portion, a portion of which is formed with a conductive yarn in a knitting form,
wherein a signal for controlling a device to be controlled is input in a touch manner by the conductive yarn.

13. The vehicle head lining of claim 12, wherein the skin portion is formed of the conductive yarn and an insulating yarn, and is manufactured by a circular knitting method.

14. The vehicle head lining of claim 13, wherein the conductive yarn and the insulating yarn include a same pattern.

15. The vehicle head lining of claim 13, wherein the conductive yarn utilizes a 60 to 140 denier twisted yarn formed by twisting two single yarns having a denier of 30 to 70.

16. The vehicle head lining of claim 12, wherein the signal input from the conductive yarn is transmitted through a signal transmission yarn which is disposed on the skin portion and is connected to the conductive yarn.
